(19) United States
(12) Patent Application Publication
(10) Pub. No.: US 2013/0179231 A1
(43) Pub. Date: Jul. 11, 2013

(54) INTELLIGENT MILESTONES FOR COLLABORATION SYSTEMS

(71) Applicants: Akram Bou-Ghannam, Lake Worth, FL (US); William Denis Schwendner, Wilton, CT (US); Christan Theo Walenta, Millbrook, NY (US); Ian Walker, Havant Hampshire (GB)

(72) Inventors: Akram Bou-Ghannam, Lake Worth, FL (US); William Denis Schwendner, Wilton, CT (US); Christan Theo Walenta, Millbrook, NY (US); Ian Walker, Havant Hampshire (GB)

(73) Assignee: International Business Machines Corporation, Armonk, NY (US)

(21) Appl. No.: 13/344,471

(22) Filed: Jan. 5, 2012

(51) Int. Cl. G06Q 10/06

(52) U.S. Cl. 705/7.38

(57) ABSTRACT

A method for using an intelligent milestone for a collaboration system includes, with a physical computing system, determining event sources for a set of events associated with a milestone object for a project, subscribing the milestone object to the event sources, receiving event notifications from the event sources for the milestone object, and applying a set of predefined logical conditions using the event notifications to determine if an objective of the milestone object is complete.

### BACKGROUND

Aspects of the present invention relate in general to collaborations systems, and more particularly, to intelligent milestones for those collaboration systems. Collaboration systems are computer applications that are used to assist users with collaborating with each other to complete projects. For example, a business entity may use a collaboration system to help its personnel collaborate to meet certain business objectives. A particular project may include several milestones. A milestone represents a particular point within the project where a certain number of goals have been completed.

Collaboration systems help people collaborate through a variety of mechanisms. For example, a collaboration system may notify the various users working on a particular project when certain objectives have been completed by others. This may be useful as some objectives are dependent upon the completion of other objectives. Additionally, the collaboration system may remind the users of the various deadlines associated with the milestones of the project. A collaboration system may also interact with other applications such as email or other business applications to help the users collaboratively complete projects in an efficient manner.

Some collaboration systems operate using an event-driven architecture. An event-driven architecture involves an event broker which receives notification of events and provides those notifications to event consumers that are interested in those events. An event can be defined as a change in state. For example, certain metrics may be used to monitor the efficiency of a business process. Such metrics may be referred to as Key Performance Indicators (KPIS). A change in a KPI may be defined as an event. The event broker which receives notification of changes in the KPI will provide notification of those events to event consumers which utilize the information associated with that KPI.

### BRIEF SUMMARY

A method for using an intelligent milestone for a collaboration system includes, with a physical computing system, subscribing a milestone object to a number of event sources according to a subscription expression associated with said milestone object, with the physical computing system, receiving event notifications from the event sources for the milestone object, and with the physical computing system, applying a set of predefined logical conditions according to a completion expression using the event notifications to determine if an objective of the milestone object is complete.

A computing system includes a processor and a memory communicatively coupled to the processor. The processor is configured to subscribe a milestone object to a number of event sources according to a subscription expression associated with said milestone object, receive event notifications from the event sources, and apply a set of predefined logical conditions according to a completion expression using the event notifications to determine if an objective of the milestone object is complete.

A computer program product for intelligent milestones for collaboration system includes a computer readable storage medium having computer readable code embodied therewith. The computer readable program code includes computer readable program code configured to subscribe a milestone object to a number of event sources according to a subscription expression associated with said milestone object, computer readable program code configured to receive event notifications from the event sources, and computer readable program code configured to apply a set of predefined logical conditions according to a completion expression using the event notifications to determine if an objective of the milestone object is complete.

### BRIEF DESCRIPTION OF THE SEVERAL VIEWS OF THE DRAWINGS

The accompanying drawings illustrate various embodiments of the principles described herein and are a part of the specification. The illustrated embodiments are merely examples and do not limit the scope of the claims.

FIG. 1 is a diagram showing an illustrative physical computing system, according to one example of principles described herein.

FIG. 2 is a diagram showing an illustrative intelligent milestone, according to one example of principles described herein.

FIG. 3 is a diagram showing illustrative build-time services for an intelligent milestone, according to one example of principles described herein.

FIG. 4 is a diagram showing illustrative run-time services for an intelligent milestone, according to one example of principles described herein.

FIG. 5 is a flowchart showing an illustrative process for operating an intelligent milestone, according to one example of principles described herein.

FIG. 6 is a flowchart showing an illustrative method for using an intelligent milestone, according to one example of principles described herein.

Throughout the drawings, identical reference numbers designate similar, but not necessarily identical, elements.

### DETAILED DESCRIPTION

As mentioned above, milestones are used by collaboration systems to denote certain checkpoints for a project. Typical collaboration systems may have automated mechanisms for collaboration. However, they are typically designed for a specific project. Collaboration systems may make use of technologies such as Business Activity Monitoring (RAM), Business Process management (BPM), and Business Event Processing (BEP) to provide the desired solutions. However, each of these tools involves the use of experts to specifically tailor the collaboration system for a particular business process. Use of these experts can be quite costly.

The present specification discloses methods and systems that utilize intelligent milestones for collaboration system solutions. Such milestones are active, reusable, and easily configurable. According to certain illustrative examples, a milestone object includes a subscription expression. The subscription expression is customized during build-time for a particular milestone. The subscription expression tells a system during runtime which events are relevant to determining whether the milestone's objective has been completed. During run-time, the milestone object will subscribe to the event sources automatically without any user intervention.

For example, a business project may involve getting a new product ready for announcement. Such a project can be a relatively process intensive activity. Specifically, several objectives must be met in order to appropriately announce the product. The marketing department needs to determine the appropriate way to market the product. This may involve interaction with the engineers to understand the product. Additionally, the product must be appropriately priced. Several milestones within the project have deadlines that have to be met in order to ensure that the process stays on schedule. For example, it may be the case that the pricing team needs to price the product at least 8 days before announcement. Such a task may be defined as a milestone.

Using this example, a milestone object is tailored for the specific task of pricing a particular product. The milestone object is configured at build-time so that during run-time, it will subscribe to certain event sources. As mentioned above, an event may be a change in the state of something. An event source is thus the entity which reports that change of state. In this case, the event source may the software application used by the pricing department. This software application may report changes in the state of the pricing for the new product. By subscribing to this event source, the milestone object for the pricing milestone will be able to receive the appropriate information that will allow it to determine whether its objective is complete.

In addition to the milestone object subscribing to the relevant events, it will also include a completion expression that is defined at run-time. When the event notifications are received by the subscribed event sources, the milestone object will apply the event notification data to the completion expression to determine if the completion condition is true. For example, in the simple example of the pricing milestone, the milestone object will apply the completion expression to the data received from the event sources to which the milestone object is subscribed. If it is determined that the completion condition is true, then the milestone object can notify the appropriate entities. Alternatively, if a deadline is approaching and the milestone is not yet complete, the milestone object may notify the appropriate entities to remind them of the upcoming deadline.

Through use of methods and systems embodying principles described herein, an intelligent milestone object is realized. Such a milestone object may be customized from a template milestone object. Additionally, specific milestone objects may be used for a variety of different projects that have similar milestones. Use of such a milestone will increase the efficiency of collaboration systems.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing, in the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

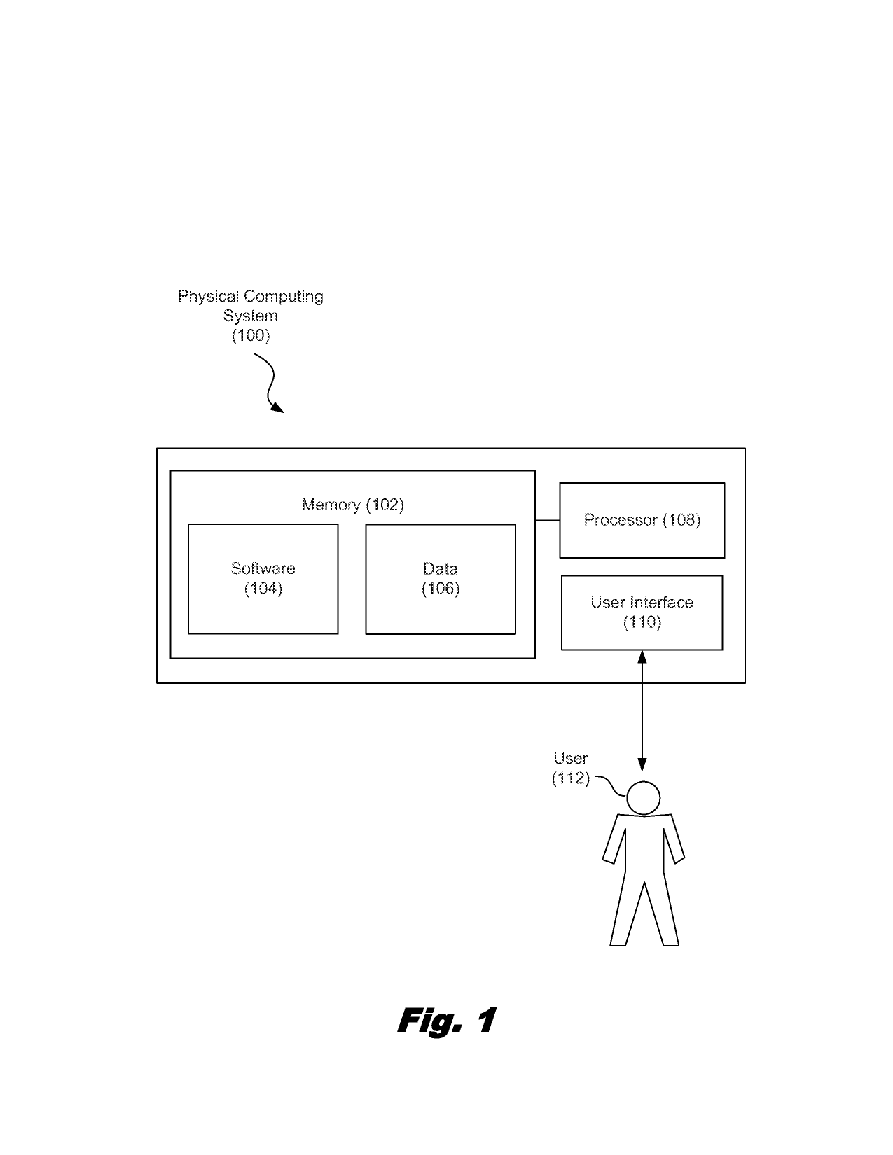

Referring now to the figures. FIG. 1 is a diagram showing an illustrative physical computing system (100) that may be used to process collaboration applications. According to certain illustrative examples, the physical computing system (100) includes a memory (102) having software (104) and data (106) stored thereon. The physical computing system (100) also includes a processor (108) and a user interface (110).

There are many types of memory available. Some types of memory, such as solid state drives, are designed for storage. These types of memory typically have large storage volume but relatively slow performance. Other types of memory, such as those used for Random Access Memory (RAM), are optimized for speed and are often referred to as “working memory.” The various forms of memory may store information in the form of software (104) and data (106).

The physical computing system (100) also includes a processor (108) for executing the software (104) and using or updating the data (106) stored in memory (102). The software (104) may include an operating system. An operating system allows other applications to interact properly with the hardware of the physical computing system.

A user interface (110) may provide a means for the user (112) to interact with the physical computing system (100). The user interface may include any collection of devices for interfacing with a human user (112). For example, the user interface (110) may include an input device such as a keyboard or mouse and an output device such as a monitor.

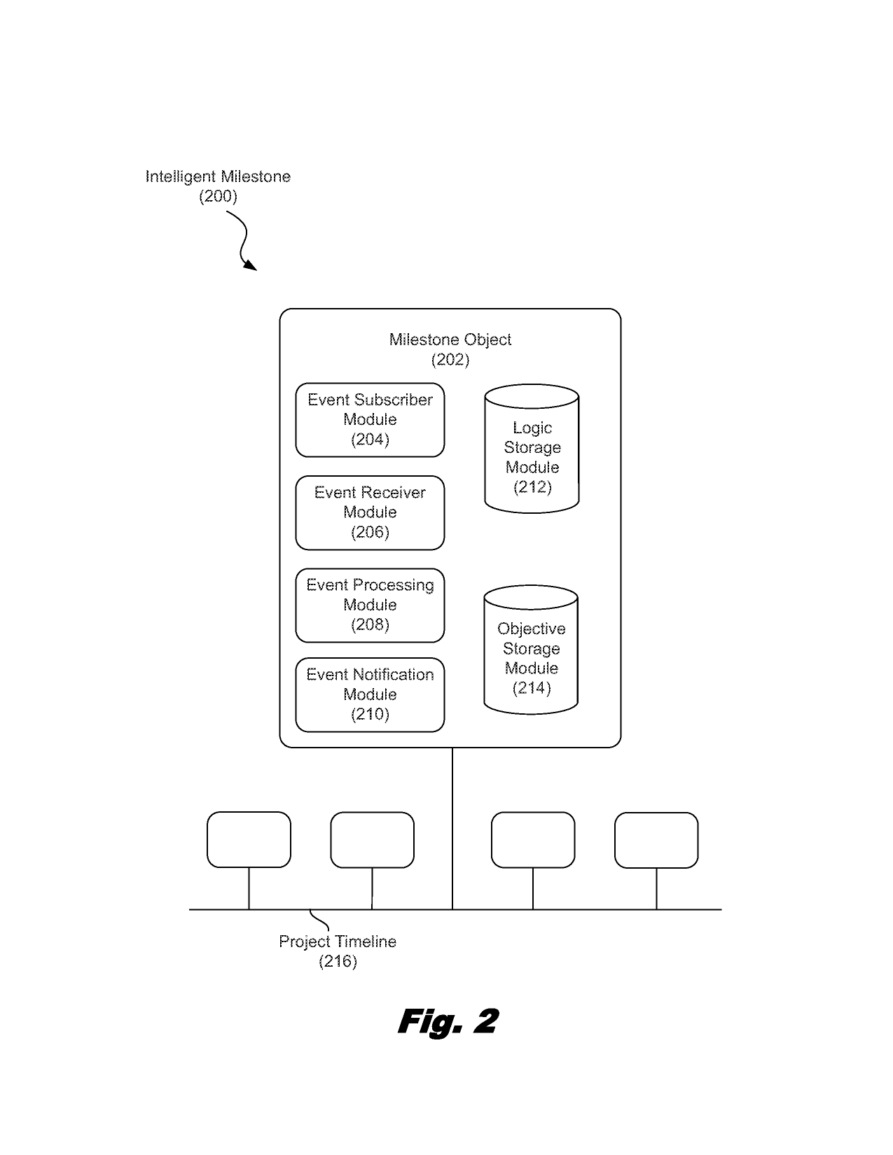

FIG. 2 is a diagram showing an illustrative intelligent milestone (200). According to certain illustrative examples, the intelligent milestone (200) may be structured as a milestone object (202). The milestone object (202) includes an event subscriber module (204), an event receiver module (206), an event processing module (208), and an event notification module (210). The milestone object (202) also includes a logic storage module (212) and an objective storage module (214).

The event subscriber module (204) is responsible for subscribing to event sources. The event subscriber module (204) determines the event sources to which the milestone object (202) should be subscribed based on the subscription expression associated with the milestone object (202) that was defined at build-time. The subscription expression defines the event sources to which the milestone object should be subscribed in order to obtain the relevant data for determining whether the milestones objectives are complete. The objectives for the milestone object (202) may be stored in an objective storage module (214). For example, using the pricing example described above, the event subscriber module (204) determines which event sources are defined in the subscription expression. These event sources will include sources that provide notification of the pricing status of a product. The event subscriber module (204) then subscribes the milestone object to those event sources. These event sources may include the pricing department software application that includes the pricing status and an application which includes a deadline by which the final pricing status is to be determined.

The event receiver module (206) receives the events provided by the event sources to which the milestone object (202) is subscribed. These events are then processed by the event processing module (208). The event processing module (208) applies a set of logical conditions defined by a completion expression that was defined at build time. The completion expression includes the logical conditions that will use information from the event sources to determine whether the milestone's objectives have been completed. These logical conditions may be stored in a logic storage module (212). For example, a logical statement may be applied to determine whether the pricing status has been finalized before the deadline. For this to be the case, the current time and date must be earlier than the defined deadline and the status of the pricing as received from the event source must indicate that the pricing status has been finalized. If these two conditions are true, then the milestone object (202) can be considered complete.

The deadline for a particular milestone object is defined relative to a project timeline (216). Specifically, the deadline for a milestone object may be defined as a specific amount of time before the final deadline of the milestone project timeline (216) to which the milestone object (202) belongs. In the example where the milestone is to price a product, the deadline for that milestone may be set to two weeks before the announcement date of pricing the product, the announcement date being the final project deadline. At run-time, a collaboration system embodying principles described herein receives “announcement” events that will indicate that a particular project is to be completed by a certain time. In response to the announcement event, the collaboration system assigns a “managed item” to a specific time-line template, and specifies the fulfillment target date for that time-line. The collaboration system then creates a specific unique instance of the timeline object with the target date specified according to the announcement event. The individual deadlines of each milestone associated with the instantiated timeline are then set relative to the final project target date.

The event notification module (210) notifies the proper entities of the status of the milestone object at the appropriate times. For example, the milestone object (202) may be configured to remind particular persons that the milestone deadline is approaching and is not yet complete. Additionally, upon completion of the milestone object's (202) objectives, the event notification module may notify other objects within the collaboration system of the milestone's completion. By so doing, the milestone object may act as an event source for other milestone objects which depend on the completion of that milestone object.

According to certain illustrative examples, the milestone object (202) may be associated with a project timeline that includes several milestone objects. A typical collaborative project includes multiple milestones. While some milestones may be done in parallel, others rely on the completion of other milestones before they can be completed. Each milestone within the project may be associated with a smart milestone object embodying principles described herein.

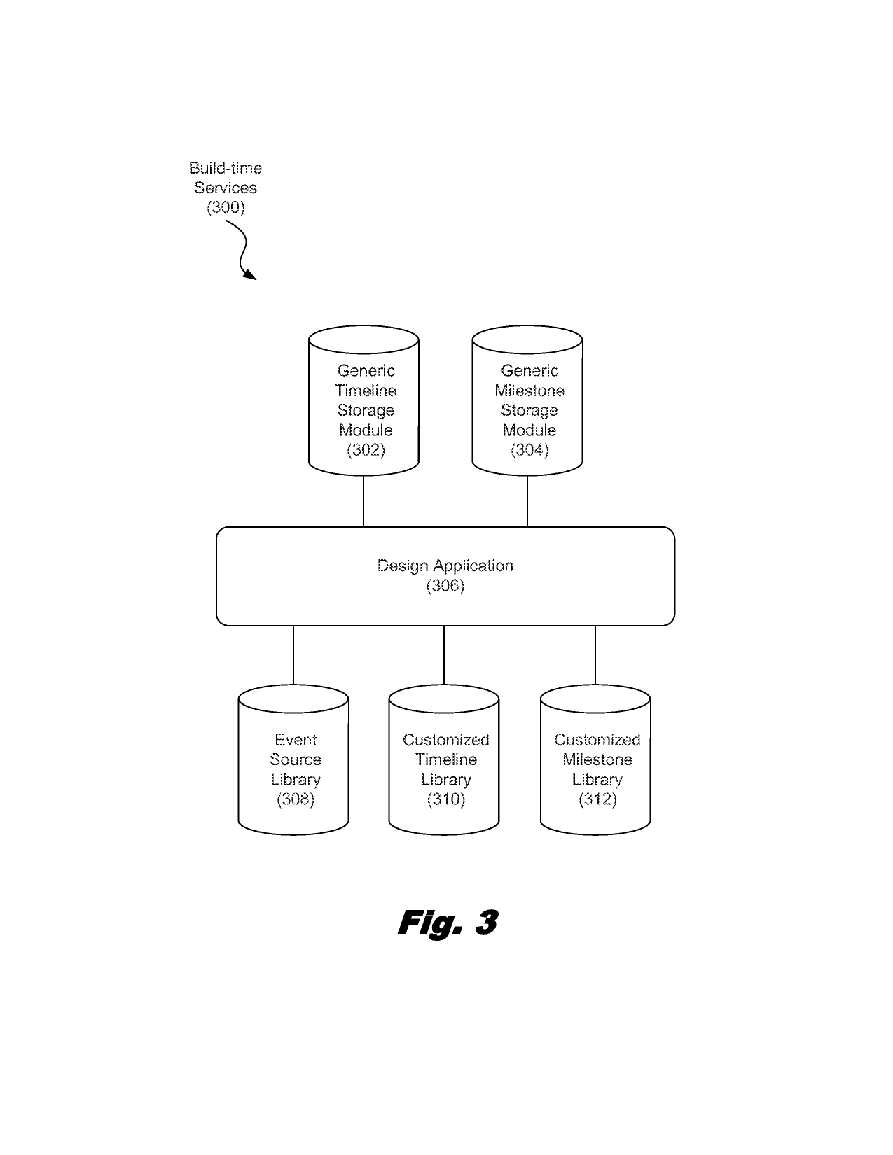

FIG. 3 is a diagram showing illustrative build-time services (300) for an intelligent milestone. According to certain illustrative examples, a milestone object may be created using a specific design application (306). The design application may utilize a generic timeline storage module (302), a generic milestone storage module (304), an event source library (308), a customized timeline library (310), and a customized milestone library (312).

The generic timeline storage module (302) is used to store templates for project timelines. As many collaborative projects are very similar, often exhibiting small differences, a collaborative project timeline may be based off of a template. The generic timeline storage module (302) may store a variety of project timeline templates for different project types. Likewise, the generic milestone storage module (304) is used to store different milestone object templates. Many milestones within a project are similar and thus use of milestone object templates is useful. The milestone object template includes a place for subscription expressions a place for a deadline, and a place for a completion expression. The milestone object may include other features such as a name, a description, and other implementation related features. Other milestone object templates may have a few basic subscription expressions which are common to many milestones. A user may customize the milestone object from a variety of general templates available.

The event source library (308) is used to store a set of available event sources to which a milestone object may subscribe. Thus, when a user is building a milestone object, he or she can browse the event source library (308) to find the event sources that provide the events relevant to that milestone object. The event source library (308) may be updated periodically to reflect changes in the available event sources.

The customized timeline library (310) includes a library of customized timelines for various projects. These timelines may have been created from a generic timeline template. Several different projects may be very similar if not identical. Thus, when starting such a project, a previously customized timeline may be used.

Likewise, the customized milestone library (312) includes a library of customized milestone objects. These customized milestone objects may have been created for a variety of previous projects. As many different projects include similar objectives, the same milestone object created for one project may be created for another. For example, a project may have a pricing objective as described in the example above. A milestone object for such an objective may be nearly identical to a milestone object for a previous project that included that same pricing objective. The user who is building the milestone object may have to change a few parameters such as the deadline. However, the rest of the milestone object is already built. Thus, intelligent milestone objects may essentially be reused for different projects. By creating intelligent milestones in such a manner, a user can efficiently create intelligent milestones that will automatically subscribe to the relevant event sources.

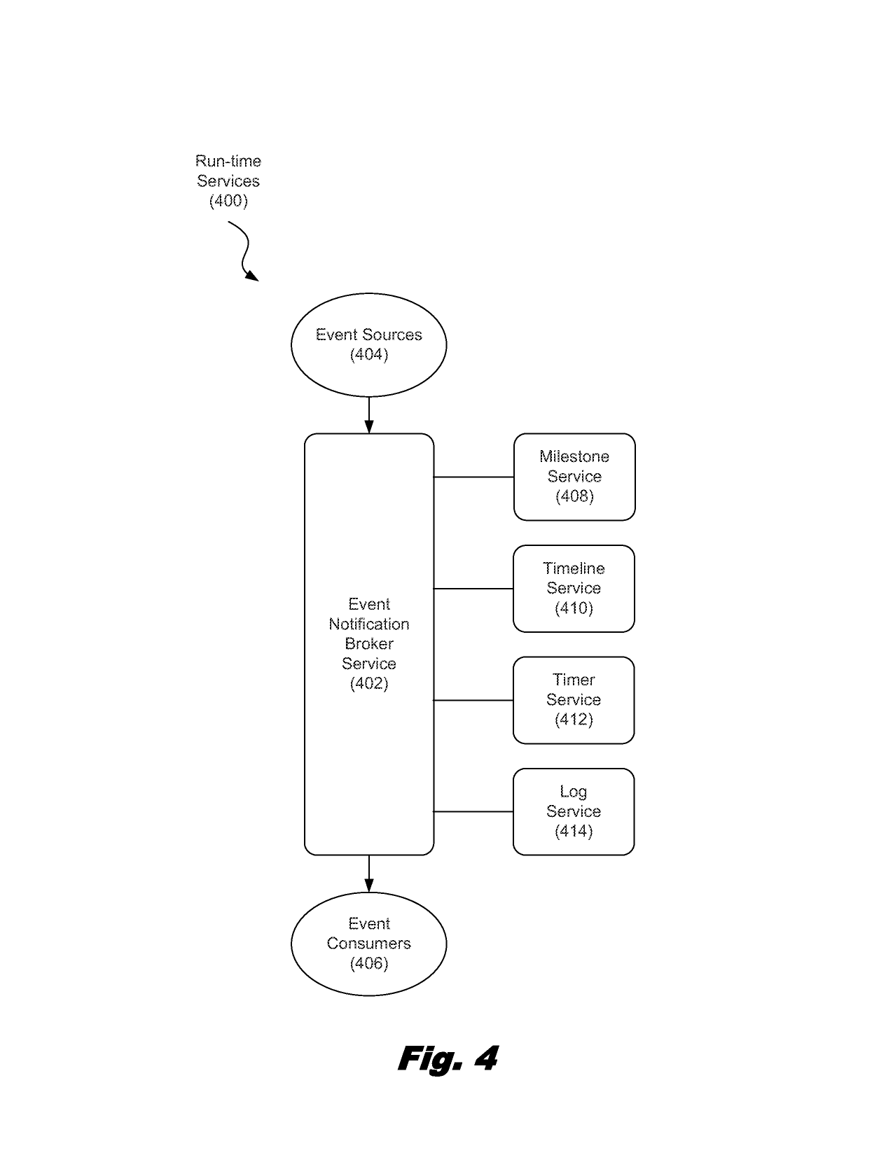

FIG. 4 is a diagram showing illustrative run-time services (400) for an intelligent milestone. According to certain illustrative examples, an event notification broker service (402) is responsible for receiving event notifications from event sources (404) and sending those event notifications to the event consumers (406). The event notification broker service (402) also utilizes a number of other services including a milestone service (408), a timeline service (410), a timer service (412), a log service (414) and a variety of other services (416).

The event notification broker service (402) is a component of an event driven architecture. In an event driven architecture, the event notification broker service (402) acts as a hub for event notifications. Event notifications are received from a variety of event sources (404). As mentioned above, an event refers to a change of state of some variable. Event sources (404) may include databases, software applications, files, etc. For example, a person may interact with a particular software application. Certain actions performed within that software application may trigger an event. In such case, the notification of that event occurrence is sent to the event notification broker service (402) which forwards the notification on to event consumers (406).

Event consumers may include databases, software applications, files, people, and dashboards. A dashboard is a display of a variety of performance indicators. Such dashboards allow users to monitor various business process performance indicators in real time. Because the dashboard relies on updates in the state of the things which it monitors, it consumes event notifications from various event sources (404).

The milestone service (408) is responsible for running the milestone objects embodying principles described herein. Specifically, the milestone service (408) subscribes milestone objects to the event sources that are relevant to the completion conditions of those milestone objects. The milestone service (408) also processes the milestone objects by applying the logic conditions associated with those milestone objects. If certain conditions have been met, such as if it is time to send out a reminder or the milestone object's completion conditions are true, then the milestone service (408) will send out an event notification to the event notification broker service (402) to be forwarded to the proper event consumers (406). The milestone service (408) may work in correlation with the timeline service (408) which is responsible for managing the project timelines that utilize the intelligent milestone objects.

The event notification broker service (402) may also use a variety of other services. These other services include a timer service (412). The timer service (412) provides timing information to the event notification broker service (402). The log service (414) includes services that will log the forwarding of event notifications through the event notification broker service (402). The list of services illustrated and described here is not intended to be an exhaustive list of every service available to an event notification broker service (402).

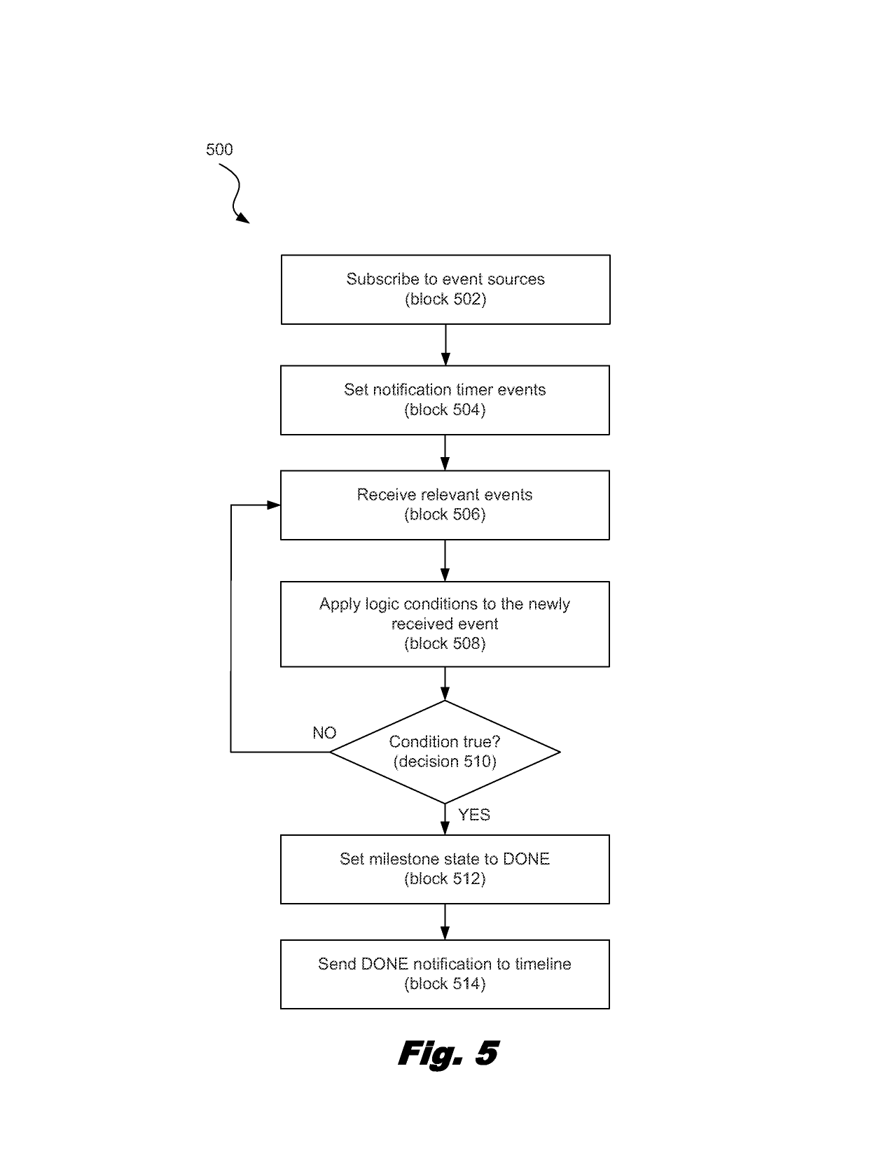

FIG. 5 is a flowchart showing an illustrative process (500) for operating an intelligent milestone. According to certain illustrative examples, the milestone object first subscribes (block 502) to event sources. The event sources to which the milestone object is subscribed are based on the subscription expression created at build-time. The subscription expression indicates the event sources to which the milestone should be subscribed in order to determine if its completion conditions are true. The milestone object will also set (block 504) notification timer events. This will set up the milestone object to send out the proper notifications in responses to certain logic conditions being applied.

After subscribing to the appropriate event sources, the milestone object will receive (block 506) the relevant events from those sources. The milestone object will then apply (block 508) its logic conditions, as defined in the completion expression, to the new information received from those event notifications. The new information may be the new state of particular variables that are relevant to determining whether the objectives of the milestone object are complete. These logic conditions will determine whether notification alerts should be sent out or if the milestones objectives have been completed.

It is then determined (decision 510) whether or not the completion conditions are true. If it is determined (decision 510, NO) that the conditions are not true, then the milestone object continues to receive additional event notifications. If it is determined (decision 510, YES) that the completion conditions are indeed true, then the status of the milestone object may be set (512) to DONE. This DONE status is then sent (block 514) out as an event notification to the timeline object associated with the milestone object. The milestone object may also send the completion notification to other event consumers such as software applications and persons associated with the project to which the milestone belongs.

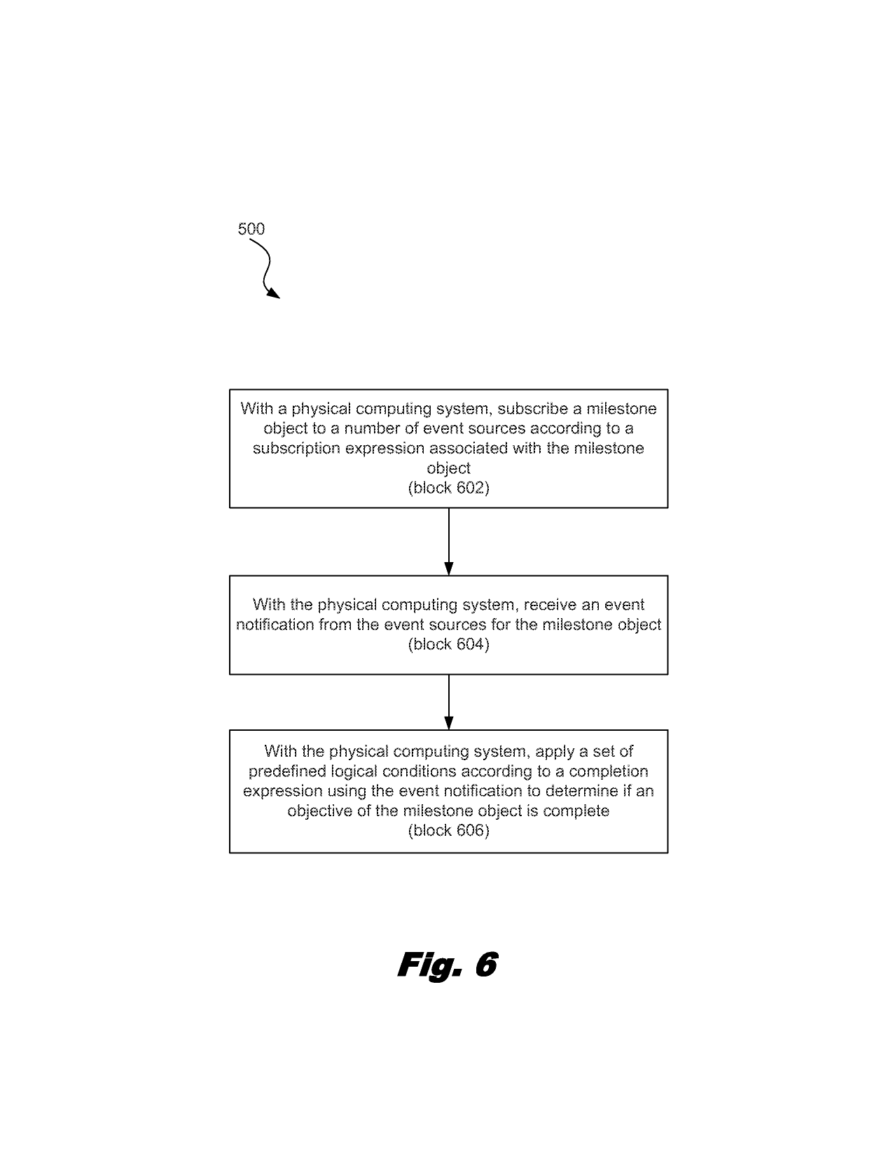

FIG. 6 is a flowchart showing an illustrative method (600) for using an intelligent milestone. According to certain illustrative examples, the method includes, with a physical computing system, subscribing (block 602) the milestone object to a number of event sources according to a subscription expression associated with the milestone object, with the physical computing system, receiving (block 604) event notifications from the event sources for the milestone object, and with the physical computing system, applying (block 606) a set of predefined logical conditions using the event notifications to determine if an objective of the milestone object is complete.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved, it will also be noted that each block of the block diagrams and/or flowchart illustration, and combinations of Hocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed, Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for using an intelligent milestone for a collaboration system, the method comprising:
with said physical computing system, subscribing a milestone object to a number of event sources according to a subscription expression associated with said milestone object;
with said physical computing system, receiving an event notification from said event sources for said milestone object; and
with said physical computing system, applying a set of predefined logical conditions according to a completion expression using said event notification to determine if an objective of said milestone object is complete.

2. The method of claim 1, wherein said milestone object is based on a template milestone object.

3. The method of claim 2, wherein said milestone object is configured by a user for said project.

4. The method of claim 1, further comprising, reusing said milestone object for a different project.

5. The method of claim 1, further comprising, alerting a user associated with said project as to a status of completed items for said milestone object.

6. The method of claim 1, wherein said milestone object is one of many milestone objects within a timeline associated with said project.

7. The method of claim 1, wherein said event sources comprise at least one of: business processes, databases, applications, and electronic files.

8. A computing system comprising:
a processor; and
a memory communicatively coupled to said processor;
in which said processor is configured to:
subscribe a milestone object to a number of event sources according to a subscription expression associated with said milestone object;
receive event notifications from said event sources; and
apply a set of predefined logical conditions according to a completion expression using said event notifications to determine if an objective of said milestone object is complete.

9. The system of claim 8, wherein said milestone object is based on a template milestone object.

10. The system of claim 9, wherein said milestone object is configured by a user for said project.

11. The system of claim 8, wherein said processor is further configured to reuse said milestone object for a different project.

12. The system of claim 8, wherein said processor is further configured to alert a user associated with said project as to a status of completed items for said milestone object.

13. The system of claim 8, wherein said milestone object is one of many milestone objects within a timeline associated with said project.

14. The system of claim 8, wherein said event sources comprise at least one of: business processes, databases, applications, and electronic files.

15. A computer program product for intelligent milestones for collaboration system, said computer program product comprising:
a computer readable storage medium having computer readable code embodied therewith, said computer readable program code comprising:
computer readable program code configured to subscribe a milestone object to a number of event sources according to a subscription expression associated with said milestone object;
computer readable program code configured to receive event notifications from said event sources; and
computer readable program code configured to apply a set of predefined logical conditions according to a completion expression using said event notifications to determine if an objective of said milestone object is complete.

16. The computer program product of claim 15, wherein said milestone object is based on a template milestone object and said milestone object is configured by a user for said project.

17. The computer program product of claim 15, further comprising computer readable program code configured to reuse said milestone object for a different project.

18. The computer program product of claim 15, further comprising computer readable program code configured to alert a user associated with said project as to a status of completed items for said milestone object.

19. The computer program product of claim 15, wherein said milestone object is one of many milestone objects within a timeline associated with said project.

20. The computer program product of claim 15, wherein said event sources comprise at least one of: business processes, databases, applications, and electronic files.
